(19) United States
(12) Patent Application Publication
(10) Pub. No.: US 2009/0201759 A1
(43) Pub. Date: Aug. 13, 2009

(54) Method for manufacturing powder coatings

(76) Inventor: Paul Mills, Brunswick, OH (US)

Correspondence Address: Paul Mills, 1477 Troon Ave, Brunswick, OH, 44212, US

(21) Appl. No.: 12/322,991

(22) Filed: Feb. 10, 2009

Related U.S. Application Data
(60) Provisional application No. 61/065,438, filed on Feb. 12, 2008.

(51) Int. Cl. B01F 11/02

(52) U.S. Cl. 366/108

(57) ABSTRACT

An improved method for manufacturing powder coatings for applications where uniform dispersion of one or more additives is critical to the function of the final coating. The method comprises ultrasonic post-blending of powder coating of one or more additives into a base powder coating material prepared by ordinary means. In one example, an antimicrobial powder coating containing a silver zeolite additive is prepared using the ultrasonic post-blending method. The resulting powder exhibits superior antimicrobial efficacy compared to an analogue powder manufactured using identical constituent ingredients, but according to conventional premix/extrusion methods. Powder manufactured using ultrasonic post-blending allows a wide range of stock powder coatings to be modified to exhibit new properties at improved cost and efficiency than conventional preparation methods. The method is suitable for powder coating formulations requiring incorporation of a small percentage of additives, especially additives with relatively small particle sizes such as nano- and sub-micron additives.

### CROSS REFERENCE TO RELATED APPLICATIONS

This application claims the benefit of Provisional Patent Application No. 61/065,438, filed Feb. 12, 2008 by the present inventor.

### FEDERALLY SPONSORED RESEARCH

Not Applicable

### SEQUENCE LISTING OR PROGRAM

Not Applicable

### BACKGROUND OF THE INVENTION

1. Field of Invention

The invention relates generally to powder coatings, and specifically to antimicrobial powder coatings and powder coatings that require the addition of small quantities of uniformly dispersed additives in the final coating.

2. Background of the Invention

Powder coatings are customarily manufactured by pre-mixing ingredients using any number of dry blending techniques, extruding the mixture, grinding the extrudate and separating the ground powder from very fine particles either by mechanical means such as sieving or by using a cyclone separator to produce a final powder coating material.

This method of premixing and extruding powder coatings is widely known to those experienced in the art and powder coatings produced in this manner are generally acceptable for a wide range of functional and decorative powder coatings which require dispersion of the ingredients into an acceptably homogenous mixture.

Some applications for powder coatings may require exceptionally high uniformity of certain ingredients for specific purposes. For example, a powder coating intended to provide antimicrobial resistance to a large surface requires uniform dispersion of the antimicrobial agents across the entire surface.

In the field of antimicrobial powder coatings, two United States Patents describe a method to provide an antimicrobial powder according to these traditional methods of premixing antimicrobial additives together with other components of the coating and extruding the powder coating. These are U.S. Pat. No. 5,980,620 to Brodie, et. al and U.S. Pat. No. 6,093,407 to Cummings, et. al. A similar process is disclosed by Magnin in his international patent application WO 2008/082535.

In a recent article The Degree of Dispersion of Pigments in Powder Coatings (Dyes and Pigments, Volume 57, Issue 3, June 2003, Pages 235-243), Kunaver, et. al. report that their investigations of additive dispersal in premix/extruded powder coatings revealed that the dispersion of a pigment in powder coatings is usually incomplete and is influenced by the properties of the pigment itself, the binder and, to a large extent, the extrusion process. Kunaver also instructs that sufficient premixing of the ingredients is especially important for materials that are used in small quantities.

These limitations of the traditional premix/extrusion method were discussed by Kim, et. al. in European Patent EP 1 559 752 A2. Kim discloses an improved method of preparing antimicrobial powder coatings by adding the antimicrobial agent to a base, or intermediate powder coating material that has been prepared by way of the premix/extrusion method. Kim discloses a method of bonding the antimicrobial additive to the prepared powder coating by heating the powder and additive mixture to a temperature of at least the glass transition temperature of the resinous base of the powder coating.

According to Kim, blending temperatures from about 30° C. to about 100° C. are necessary in order to achieve fusing the additive to the powder resin particles. Kim further describes a blending apparatus similar to that described in U.S. Pat. No. 5,187,220 to Reichert, et. al. intended for bonding metallic flake to powder coatings. The apparatus described is a high shear mixer utilizing rotating blades.

A similar process of post blending powder coatings with additives such as pigments and gloss modifying agents is described by Ring et. al. in U.S. Pat. No. 5,856,378. Ring instructs on a method to prepare coatings by fusing powder agglomerates to additives by mixing the particles together in a high shear mixer at temperatures in the range of 60° C. to 80° C. Ring describes a modified food mixer that utilizes a high velocity air stream to cool powder near the blades of the proposed mixer to prevent impact fusion on the blades of the mixer.

The problems associated with the post blending method described in the prior art is that uniform dispersion of additives is hindered when the additive bonds to the powder in a non-homogenous fashion caused by non-uniform heat distribution, impact fusion on the blades of the mixing apparatus or inadequate blending. Non uniformity of heat distribution in the apparatus is due to the construction and arrangement of the various mechanical components of the mixer and inherent in mechanical mixing processes. Non homogeneity of the boning or fusing of agglomerates is further exacerbated by the varying particle size distribution, particle shape and densities of the powders being mixed.

The mechanics of blending powder coatings has to date involved the principles of shear, convection, and diffusion (or dispersion), achieved by the use of industrial blenders or mixers. The equipment employed to accomplish the process of powder blending in the prior art can be categorized as either 1) rotating or 2) fixed shell blenders. Rotating shell blenders (i.e., drum, cross-flow, double cone, and twin-shell types) accomplish the powder mixing process by rotating the blender shell around a fixed axis and by relying upon a sliding or rolling motion of the powder. To aid in this mixing process, many systems will utilize internal baffles. Fixed shell blenders (i.e. ribbon, screw, and impeller mixers), on the other hand, rotate internal blender parts, such as an impeller or paddle, and produce a continuous cutting and shuffling motion. Shearing force that breaks apart large conglomerates of powder is, therefore, developed by this kind of cutting and shuffling motion. Pony, planetary, and high shear mixers have also been used in conjunction with blenders for mixing powder coatings.

In U.S. Pat. No. 4,571,086, Wooten et. al. describes a process for preparing ceramic powders for sintering. Wooten instructs that the process comprises the steps of dispersing the sintering powders and sintering aids in a low boiling point dispersing liquid to form a suspension. The suspension is then ultrasonically vibrated to defloculate agglomerates which may have formed and continuing to ultrasonically vibrate the suspension until the solvent evaporates. Wooten instructs that the resultant material is a homogeneous mixture.

In U.S. Pat. No. 7,083,322 B2 Moore, et. al also describe a method of preparing a liquid coating using an ultrasonic dispensing system to incorporate additives into a base resin. In Moore, a ultrasonic sonotrode is immersed in a mixing vessel and supplies ultrasonic energy to provide uniform dispersion of additives such as colorants, modifiers, pigments, etc.

The benefit and efficacy of ultrasonic mixing of powders is presented by Burr et. al. in International Publication Number WO 2005/025730 A1. Burr instructs that acoustically fluidizing powder particles can be used to prepare highly uniform dispersions without the deleterious effects of impeller blades and heat generation. According to Burr, ultrasonic powder blending for periods of two minutes resulted in mixtures with a 2% relative standard deviation (RSD) attesting to excellent homogeneity.

### BRIEF SUMMARY OF THE INVENTION

The prior art illustrates the difficulty of manufacturing powder coatings which must contain a uniform dispersion of additives through out the powder coating to achieve their performance properties. The manufacturing problem is magnified when a small volume of additive must be well dispersed in a large volume of powder material, and is further hindered when the particle size of the additive is relatively small.

The current prevailing methods of preparing powder coatings with these properties which rely on premixing additives and extruding the powder is also poorly suited to preparing small and medium size batches of powder coating.

The Proposed Method Described herein has the Following Benefits and Advantages;

(a) A final powder coating material is obtained wherein an effective amount of the required additives are well dispersed. Uniform dispersion provides a coating that exhibits uniform performance properties across the entire surface the powder is applied to. This is especially critical in applications where the normal variation in dispersion that can be achieved using conventional premix and extrusion techniques are less effective such as antimicrobial resistance.

(b) Ultrasonic mixing of additives provides improved dispersion by eliminating non-homogeneities resulting from powder particle melting and fusion to mechanical apparatus found in conventional mixing equipment described in the prior art. This improvement is most pronounced on powder coating and additives with either lower glass transition temperatures, fine particle sizes, or where larger variations in particle size distribution may be present.

(c) Ultrasonic post blending of powder coatings improves the dispersion of additives in the powder coating base material by eliminating the heat generated by mechanical mixing apparatus described in the prior art.

(d) The present invention is most suitable for small and medium size batches of powder coatings ranging from 1.5 liters to 200 liters. Batches of this size are less suited to the prevailing premix/extrusion manufacturing methods described in the prior art since typical production extruders require larger volumes of raw materials and the required extruder cleaning time and cost between batches to prevent contamination makes small volume production more costly and less efficient.

(e) The present invention permits incorporation of additives into a wide range of previously prepared powder coating resin chemistries and curing mechanisms since rather than heating the materials to the glass transition temperature, the materials are ultrasonically blended at temperatures lower than the glass transition temperature.

(f) The ultrasonic post blending provides dispersion equal to or greater than conventional premix/extrusion methods yielding comparable or superior performance of the final powder coating. Experimental observations of the efficacy of sonic blending have been reported in the literature with dispersion quality of 2% relative standard deviation (RSD).

(g) The present invention is suitable for a wide range of additives. Additives may be dry blended even if they have a wide range of particle size, shape, glass transition temperature or other morphological or chemical characteristics. Sonic blending is well suited to sub-micron size particulate which poses difficulties for traditional

(h) While various preferred embodiments have been described, those skilled in the art will recognize modifications or variations which might be made without departing from the inventive concept. The examples illustrate the invention and are not intended to limit it. Therefore, the description and claims should be interpreted liberally with only such limitation as is necessary in view of the pertinent prior art.

### DETAILED DESCRIPTION OF THE INVENTION

Powder coatings are a well established means of finishing a wide range of objects. Powder coating is often selected from among a number of alternate paint and coating technologies to provide cosmetic and/or protective properties to a range of manufactured goods. Powder coatings are typically applied either electrostatically or using a flame spray technique. Once applied, powder coatings are heated to melt and flow the powder into a continuous film. The powder is then cured either with thermal energy (typically convection or infrared heat) or by exposure to UV light in the case of radiation cured powder coatings. Curing powder gives the film it's final cosmetic and durability properties.

Powder coatings are normally formulated by combining a number of constituent ingredients including but not limited to resins, fillers, cross linking agents, pigments, and a number of additives to control flow, rheology, gloss and other properties. This process is well understood by practitioners of the art and fully described in the technical literature (see for example Powder Coatings Chemistry and Technology, T. A. Misev, 1991, John Wiley and Sons, Ltd.).

The powder coating resin may be one or more of the thermosetting and/or thermoplastic resins including those based on epoxy, polyester, acrylate, acrylic, polysiloxane and/or polyurethane resins.

Examples of thermoplastic or thermosetting coatings that may be used, include: but are not limited to epoxies, saturated and unsaturated polyesters, carboxylic acid-functional polyesters, hydroxyl-functional polyesters, epoxy/polyester hybrids, acrylics, epoxy/acrylic hybrids, glycidyl-functional acrylics, polyester-urethanes, acrylic urethanes and siloxanes. Thermoplastic powder coatings that may be useful include, but are not limited to nylon, polyvinyl chloride (PVC), polyethylene, polyethylene terephthalate (PET), polybutylene terephthalate (PBT), and polypropylene as examples. These powder coatings may be cured or fused by thermal or photochemical methods.

In common practice, powder coating resins, fillers and pigments comprise from 80%-99% of the total composition (by weight) of the final material. The coating may also include from about 0.1 percent to about 20 percent by weight of the total composition of one or more anti-microbial agents.

The anti-microbial agents include but are not limited to phthalimides, acetamides, phthalonitriles, hydroxy benzoates, isothiazolinones, nitropropane diols, carbamates, methyl ureas, benzimidazoles, salicylanilides, mercury acetates, organozinc compounds, metals such as silver, copper and zinc, and ions of such metals.

Metals such as silver, copper and zinc and ions of such metals also have anti-microbial properties. Silver ions have widespread effect as an anti-microbial agent. For example, silver ions may be effective against bacteria such as Escherichia coli and Salmonella typhimurium, and mold such as Asperigillus niger.

Sources of silver for anti-microbial use include metallic silver, silver salts and organic compounds that contain silver. Silver salts may include for example: silver carbonate, silver sulfate, silver nitrate, silver acetate, silver benzoate, silver chloride, silver fluoride, silver iodate, silver iodide, silver lactate, silver nitrate, silver oxide and silver phosphates. Organic compounds containing silver may include for example, silver acetylacetonate, silver neodecanoate and silver ethylenediaminetetraacetate in all its various salts.

Silver containing zeolites (for example, AJ10D containing 2.5% silver as Ag(I), made by AgION™ Tech. L.L.C., Wakefield, Mass. 01880) are of particular use. Zeolites are useful because when carried in a polymer matrix they may provide silver ions at a rate and concentration that is effective at killing and inhibiting microorganisms without harming higher organisms.

The most widely used manufacturing method for producing powder coatings is to mix all of the dry ingredients to their proper proportions in a process commonly referred to as weigh up. The ingredients are then typically mixed together is a large industrial mixer until well blended. Mixers used for this purpose are frequently cone mixers, ribbon blenders, and similar mechanical mixers incorporating stirring bars, paddles or blades to incorporate the various ingredients into a homogeneous mixture.

As described by Misev, premixing of the ingredients of the powder prior to hot melt compounding is an operation whose importance must not be ignored. This step of the powder coating manufacture sometimes plays a decisive role in determining the performance of the coating. Insufficient premixing of ingredients, especially those which are employed in small concentrations such as additives and tinting pigments cannot be compensated for later on.

This pre-mixture is then introduced to a powder extruder where the material is heated to a temperature above the glass transition temperature of the resin, but below the curing temperature of the powder coating.

The mixture is extruded at this high temperature and under high pressures to form a homogenous extrudate. This extrudate is then chopped into smaller particles in an apparatus such as a hammer mill, a pin disk mill, jet mill or other suitable grinding device. The ground particles are classified by size using a sieve or cyclone classifier to separate out particles of desired particle size range from those of too large a granular size or from fine particles below the target particle size range.

For many traditional powder applications this combination of pre-mixing ingredients and extruding them into a single extrudate which is then processes into small particles is acceptable. However the use of mechanical impeller blades, the heat generated during mixing and the difficulty of dispersing a small quantity of a single additive into a relatively large volume of other constituents is inadequate to provide the uniformity of dispersion required for some other applications.

Another problem with the premix/extrusion process is that while it may be suitable for large production batches, the inefficiencies of loading the extruder and cleaning it out between batches makes it inefficient for producing smaller volumes of powder.

The present invention utilizes a post blending process of preparing powder coatings that require a high degree of additive dispersion.

The technique is analogous to the common method mixing colored house paints at the local hardware store. In that case, a small volume of paint can be prepared by post-blending an appropriate color pigment into an intermediate “base tint” material. This eliminates the need to stock large volumes of many different colors and provides the ability to create virtually and shade of color as needed.

The present invention utilizes ultrasonic blending to incorporate small quantities of additives to a already prepared power coating to provide additional properties such as antimicrobial activity, fingerprint resistance, and other properties. There is a commercial value to being able to modify otherwise complete powder coatings to exhibit antimicrobial properties on an as-needed basis.

In the present invention, a varying degree of additive from less than 1% to as much as 20% by weight (of the final coating weight) can be incorporated into the base powder coating.

The additive particle shape and particle size distribution can vary among a wide range of shapes and sizes. Additives with particle sizes ranging from of less than 1 micron to as large as 90 microns can be incorporated and effectively dispersed.

Additives can incorporated into a wide range of powder resin types including epoxy, polyester, acrylic, hybrid, polyester-TGIC, GMA acrylic fluorocarbon, thermoplastic vinyls, polyolefins, nylons, etc.

Radiation curable power coatings are also well known in the art and additives can be incorporated into UV curable powder coatings.

The mixing device shall be an acoustic fluidized bed type of device, generally referred to as a sonic or ultrasonic mixer. Sonic mixers made by DIT Inc., (Warrenton, Va.) are of particular use. The mixing chamber can be as small as 2.0 liters or as large as 200 liters and constructed of a suitable material such as plastic or stainless steel. The acoustic wavelength and saw-tooth wave pattern is selected based on the volume of material, density and relative particle size of the constituents but ordinarily ranges from 10 Hz to 250 Hz.

To maintain mixing temperatures below the glass transition temperature of the lowest melting resinous material in the powder mixture, the entire mixing chamber may be placed in a refrigerated environment, or a cooling jacket may be used to enclose the mixing chamber to keep particulate below the prescribed glass transition temperature threshold.

### EXAMPLE

### Antimicrobial Powder

Preparation:

In this example, a base powder coating material described as Base A, consisting of the following formulation was prepared:

### Test Material: Base ‘A’

| Ingredient | Function | % Weight |
|---|---|---|
| Crylocoat 2441-6 | Carboxyl-Polyester Resin | 63.7 |
| AAL Chem TGIC-N | Triglycidyl isocyanurate curing agent | 4.8 |
| Resiflow P-67 | Flow additive | 1.0 |
| Benzoin | Outgassing additive | 0.5 |
| Kronos 2160 TiO2 | Pigment | 30.0 |

The above composition was dry blended using a commercial grade tabletop mixer and then extruded in an APV 19 mm, co-rotating, twin-screw extruder. The extrudate was cooled, chopped and ground to a mean particle size of approximately 45 microns.

431 grams of the “base” powder coating material was then placed into the chamber of a 2-liter sonic blender manufactured by Design Integrated Technology Inc., (“DIT”) (Warrenton, Va.)

23 grams of a silver zeolite antimicrobial agent was also added to the DIT Sonic Blender chamber so that the resulting mixture was 95% base powder and 5 antimicrobial additive. The sonic blender was operated at a nominal frequency of 100 Hz for approximately 3 minutes. This powder is referred to below as “Post-Blended AM Powder”

In a second formulation 431 grams of Base A test material was blended conventionally with 23 grams of the same silver zeolite antimicrobial additive in a manner consistent with normal premix/extrusion powder coating preparation. This mixture was then extruded, ground and classified into a single antimicrobial powder coating with a mean particle size of approximately 45 microns. This powder is referred to below as “Extruded AM Powder”

Finally, a 453 gram sample of Test Material “Base A” was prepared by premixing the ingredients, extruding the mixture and processing the extrudate by grinding and classifying it into a powder coating of mean particle size of 45 microns. This powder coating contained all of the same ingredients except that an antimicrobial agent was omitted. This powder coating is referred to below as “Control NOAM”

Test I.

Each of the sample powder coatings above were electrostatically applied to standard steel test panels supplied by Q-Labs (Westlake, Ohio) at an film thickness of approximately 37.5 microns (1.5 mils). The powder was cured in a as fired convection oven at a temperature of 375° F. for 25 minutes. Cure was verified using 50 rubs of Methyl Ethyl Ketone on a cotton swab applicator.

The prepared test panels were then cut into 50 mm×50 mm segments and test for antimicrobial efficacy according to the industry accepted test method JIS Z 2801.

Test panels were subjected to test inoculums containing the following bacteria: E. coli (ATCC 11229), S. aureus (ATCC 6538) and P. aeruginosa (ATCC 5442). A control sample of

| | | | Extruded | |
|---|---|---|---|---|
| | Starting | Control | AM | Post-Blended |
| Organism | Cells | (NOAM) | Powder | AM Powder |
| E. coli (ATCC 11229) | 3.4 × 10⁸ | 4.5 × 10⁸ | 2.1 × 10⁶ | 4.2 × 10² |
| S. aureus (ATCC | 8.1 × 10⁷ | 5.7 × 10⁷ | 1.5 × 10⁵ | 2.0 × 10¹ |
| 6538) | | | | |
| P. aeruginosa (ATCC | 7.5 × 10⁷ | 1.1 × 10⁸ | 3.5 × 10⁵ | 5.0 × 10¹ |
| 15442) | | | | |

The results in the table above confirm that without addition of an antimicrobial agent, there is 24-hour growth of the original inoculums for each test organism. The test also confirms that the efficacy of the powder coating prepared using traditional premix/extrusion methods exhibited a 2-3 Log 10 reduction in bacterial cells while the ultrasonically post-blended powder coatings exhibited approximately 6 Log 10 reduction in bacterial cells.

Test II.

To assess the long-term stability of post-blended antimicrobial powder formulations prepared by the present method, steel test panels supplied by Q-Lab Corporation (Westlake, Ohio) were powder coated electrostatically with both the Post-Blended AM formulation, and the Control (NOAM) formulation described in Test I above. The coating film thickness on each test panel was nominally 37.5 microns.

One pound (453 grams) of Post-Blended AM formulation were then sealed in a plastic storage container and subjected to normal activity (storage, transport, temperature/humidity variation) for a period of 12 months. At the conclusion of the 12-month period, duplicate panels were prepared in the same manner as the test panels described above.

All panels were then sectioned into 50 mm×50 mm segments and tested for bactericidal efficacy according to the industry accepted test method JIS Z 2801. Test panels were subjected to test inoculum containing S. aureus (ATCC 6538) bacteria.

The chart below summarized the findings of this shelf/storage stability test:

| | Starting Cells | Control | New Powder | 12 Mo. Old |
|---|---|---|---|---|
| S. aureus | 3.2 × 10⁶ | 5.0 × 10⁶ | 3.0 × 10¹ | 9.0 × 10¹ |

As evidenced by the JIS Z 2801 test, the antimicrobial efficacy of the coating was not adversely affected by the 12-month duration.

What is claimed is:

1. A method of making a powder coating comprising:
(a) providing a resinous powder coating comprising of a resinous base composition and at least one coating additive.
(b) adding to said resinous powder coating an effective amount of a solid additive.
(c) ultrasonically blending said powders at a temperature below the glass transition temperature of the powder coating.
(d) continuing to ultrasonically blend said powders until they are fully dispersed.

2. The process of claim 1 wherein said additive in claim 1 (b) is an antimicrobial agent.

3. The process of claim 1 wherein said additive in claim 1 (b) is an antimicrobial additive comprised of one or more antimicrobial metals or ions.

4. The process of claim 1 wherein said additive in claim 1 (b) is a silver metal or silver ion

5. The process of claim 1 wherein said additive in claim 1 (b) a silver metal or silver ion delivered by a silver zeolite.

6. The process of claim 1 wherein said additive in claim 1 (b) is a silver salt.

7. The process of claim 1 wherein said additive in claim 1 (b) contains silver delivered by an organic compound containing silver.

8. The process of claim 1 wherein said additive in claim 1 (b) is an antimicrobial additive comprised of anatase titanium dioxide, or nano-particulate titanium dioxide.

9. The process of claim 1 wherein said additive in claim 1 (b) is an additive where particle size of said additive is between 0.5 microns and 90 microns.

10. The process of claim 1 wherein said additive in claim 1 (b) comprises between 0.5% and 20% of the final powder coating material by weight.

11. The process of claim 1 wherein said powder coating in claim 1 (a) is a thermoset powder coating.

13. The process of claim 1 wherein said powder coating in claim 1 (a) is a thermoplastic powder coating.

14. The process of claim 1 wherein said powder coating in claim 1 (a) is a radiation curable powder coating.

15. The process of claim 1 wherein said blending apparatus is enclosed in a refrigerated chamber.

16. The process of claim 1 wherein the mixing vessel of said blending apparatus is enclosed by a water cooled jacket.
